(19) United States
(12) Patent Application Publication
(10) Pub. No.: US 2017/0289086 A1
(43) Pub. Date: Oct. 5, 2017

(54) MESSAGING SYSTEM WITH MESSAGE MANAGEMENT CONTROL

(71) Applicant: POLUS LLC, Westmont, IL (US)

(72) Inventors: Joe GROTTO, Winfield, IL (US); Emmitt SOUTH, Westmont, IL (US)

(21) Appl. No.: 15/450,708

(22) Filed: Mar. 6, 2017

Related U.S. Application Data
(60) Provisional application No. 62/315,001, filed on Mar. 30, 2016.

(51) Int. Cl. H04L 12/58

(52) U.S. Cl. CPC H04L 51/22; H04L 51/16; H04L 67/42

(57) ABSTRACT

A server maintains message status information for a plurality of messages. The status information includes an indicator for each message that indicates if a reply is required. A view is provided on a client device that shows only messages for which a reply is required by the first client device according to the message status information. The view is displayable on a display of the client device.

### FIELD OF THE DISCLOSURE

The present disclosure relates generally to mobile communications and messaging, and more particularly to methods, apparatuses and systems for instant messaging.

### BACKGROUND

Instant messaging (IM) applications have become widely used and in many situations have become preferred by users over e-mail. One reason for preferring IM over email is the concept of presence. In most messaging applications the user can be aware of their contacts' (often recorded in a “friends list” or “buddies list”) status such as when their contacts are online, off-line, busy, or available at a particular time. Therefore use of the messaging application is more likely to elicit a response when a user is online or available than is an e-mail message which may not be viewed by the recipient until a much later time.

Nevertheless, the advent of increased use of messaging applications, including as a substitute for e-mail, has resulted in users being inundated with large amounts of instant messages similar to what has happened during the introduction of e-mail as a business communication tool (i.e. users suffer from e-mail information overload).

Keeping track of the various instant messages received has therefore become cumbersome, and has even rendered the instant messaging system to be as daunting as e-mail for some users given the amount of messages that can be received on any given day. Because instant messaging is increasingly used as a business communication tool, responses to instant messages can be more critical for certain users that use instant messaging as more than just a media for socializing.

Furthermore, instant messaging has created other concerns for business operations. For example, keeping records of instant messaging communications can be challenging given the somewhat ephemeral nature of instant messaging versus the more established structured storage regimes in place for e-mail servers and systems. In other words, instant messaging has become another form of electronically stored information (ESI) that must be accounted for by businesses and which may create a liability. In some instances, preservation obligations may exist such as in a litigation situation or for other regulatory compliance purposes. However instant messaging communications are not well-suited to litigation holds or other compliance purposes as ESI given their somewhat ephemeral nature.

### BRIEF DESCRIPTION OF THE DRAWINGS

FIG. 1 is a block diagram of an example messaging system with message management control in accordance with various embodiments.

FIG. 2 is a message flow diagram of various example operations of a messaging system in accordance with an embodiment.

FIG. 3 is a set of example client device display screenshots showing application of recap settings in accordance with an embodiment.

FIG. 4 is a flowchart illustrating an example recap operation on a client device in accordance with an embodiment.

FIG. 5 is a flowchart illustrating an example recap operation on a server in accordance with an embodiment.

FIG. 6 is a set of example client device display screenshots showing recap operation in accordance with an embodiment.

FIG. 7 is a flowchart illustrating an example message type determination operation on a server in accordance with an embodiment.

FIG. 8 is a set of example client device display screenshots showing an example lock operation in accordance with an embodiment.

FIG. 9 is a flowchart illustrating example messaging system operations including recap operations and lock operations in accordance with an embodiment.

FIG. 10 is a flowchart illustrating an example lock operation in accordance with an embodiment.

FIG. 11 is a diagram of a message status table in a database in accordance with an embodiment.

### DETAILED DESCRIPTION

Briefly, the present disclosure provides a messaging platform with message management control. The message management control enables user to have awareness of messages requiring a reply by way of a recap view and provides the ability to lock certain messages to prevent inadvertent deletion.

One aspect of the present disclosure is a method that includes maintaining, by a server, message status information for a plurality of messages. The status information includes an indicator for each message that indicates if a reply is required. A view is provided, for example, to a first client device, of only messages for which a reply is required by the first client device according to the message status information. The view is displayable on a display of the first client device. In some embodiments, the view may be provided to the first client device as a thread, where the thread corresponds to a second client device in communication with the first client device. The view may also be provided as a plurality of threads, where each thread corresponds to communication with a different client device corresponding to a different user in communication with the first client device, and where each thread comprises a message requiring a reply by the first client device.

In some embodiments, the method may include determining by the server that a message sent to the first client device requires a reply by the first client device, and updating the message status information to indicate that the message requires a reply. In some embodiments, the server is operative to make this determination by reviewing the message for inquiry words.

The server may determine that a message in the view has been replied to by the first client device and may update the message status information such that the message will be removed from the view. The server may also determine that a message in the view has been replied to by the first client device and remove the replied to message from the view.

Another aspect of the present disclosure is a messaging system that includes a database operative to store message status information for a plurality of messages for a plurality of client devices. A server is operatively coupled to the database and is operative to: maintain the message status information for a plurality of messages where the status information includes an indicator for each message that indicates if a reply is required; and is operative to provide a view to a first client device, of only messages for which a reply is required by the first client device according to the message status information.

In some embodiments, the server is operative to provide the view to the first client device as a thread where the thread corresponds to a second client device in communication with the first client device. The server may also be operative to provide the view as a plurality of threads where each thread corresponds to communication with a different client device corresponding to a different user in communication with the first client device, and where each thread includes at least one message requiring a reply by the first client device.

The server is further operative to determine that a message sent to the first client device requires a reply by the first client device and to update the message status information in the database to indicate that the message requires a reply. In some embodiments, the server may be further operative to determine that a message sent to the first client device requires a reply by the first client device, by reviewing the message for inquiry words.

The server is operative to determine that a message in the view has been replied to by the first client device and accordingly update the message status information such that the message will be removed from the view. The server is further operative to determine that a message in the view has been replied to by the first client device and accordingly remove the replied to message from the view.

Another aspect of the present disclosure is a method that includes: establishing, by a first client device, an Internet Protocol (IP) connection with a server; receiving by the first client device, a plurality of messages with each message including a status indicator from the server that indicates whether a reply is required; and displaying on a display of a first client device, a view showing messages that require a reply based on the messages' corresponding status indicators. In some embodiments, the method includes displaying the view at a predetermined time. The method may further include displaying the view as a plurality of threads where each thread corresponds to communication with a different client device corresponding to a different user, in communication with the first client device, and where each thread includes a message requiring a reply by the first client device.

The method may also include determining that the first client device has replied to the first message; and removing the first message from the view. The method may also include detecting expiration of a timer setting where the timer setting indicates the predetermined time, and displaying the view at the time of expiration of the timer setting. The method may further include detecting user input to select a first message shown in the view; determining that the user has scheduled a reply to the first message; and removing the first message from the view. The method may further include sending an indicator to the server to notify the server of the scheduled reply to the first message.

Another aspect of the present disclosure is a client device that includes a transceiver, operative to establish a wireless Internet Protocol (IP) connection with a server; a display; and at least one processor, operatively coupled to the transceiver and to the display. The processor is operative to: receive a plurality of messages with each message including a status indicator from the server that indicates whether a reply is required; and display on the display, a view showing messages that require a reply based on the messages' corresponding status indicators.

The processor may be further operative to display the view on the display at a predetermined time. The processor may be further operative to display the view as a plurality of threads where each thread corresponds to communication with a different client device corresponding to a different user, and where each thread includes a message requiring a reply by the client device.

The processor may be further operative to determine that the client device has sent a reply to the first message and remove the first message from the view. The processor may also detect expiration of a timer setting, where the timer setting indicates the predetermined time, and display the view at the time of expiration of the timer setting. The processor may also detect user input to select a first message shown in the view; determine that the user has scheduled a reply to the first message; and remove the first message from the view. The processor may send an indicator to the server to notify the server of the scheduled reply to the first message.

Another aspect of the present disclosure is non-volatile, non-transitory computer readable memory that contains executable instructions, for execution by at least one processor, that when executed, cause the at least one processor to operate in accordance with client device functionality herein disclosed. Yet another aspect of the present disclosure is non-volatile, non-transitory computer readable memory that contains executable instructions, for execution by at least one processor, that when executed, cause the at least one processor to operate in accordance with a server module, message recap module, message locking module and/or message type engine functionality herein disclosed.

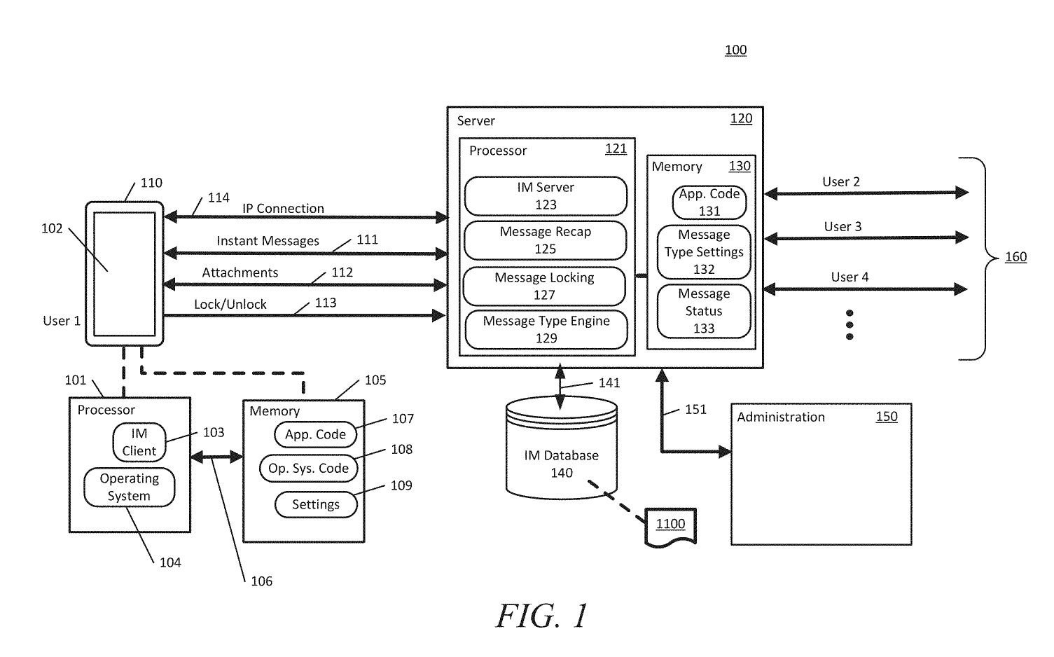

Turning now to the drawings wherein like numerals represent like components, FIG. 1 is a block diagram of an example messaging system 100 with message management control in accordance with various embodiments. The messaging system 100 includes a server 120 that is operative to communicate with various client devices such as client device 110. Client device 110 may be a computing device such as, but not limited to, a mobile telephone (smart phone), a tablet computer, laptop computer, a desktop computer, or any other computing device capable of connecting to the Internet and running applications on a processor contained within the computing device.

The example client device 110 shown in FIG. 1 is a mobile telephone that includes a display 102, a processor 101, and a nonvolatile, non-transitory memory 105. The processor 101 is operatively coupled to the memory 105 by read/write interface 106. The processor 101 is operatively coupled to the display 102 and operative to display a graphical user interface (GUI) and other information to the user. The client device 110, in the example of FIG. 1, is operated by a first user (i.e. “user 1”) and is operative to communicate with a group of other client devices 160 in order to communicate with various otherusers.

The processor 101 is operative to execute operating system code 108 from memory 105 in order to implement operating system 104, and is also operative to execute various application code 107 in order to implement, among other applications, IM client 103. The memory 105 also stores various settings 109 which may be changed by the user.

The client device 110 is operative to establish an IP connection 114 with the server 120 and to send and receive instant messages 111 which are handled by the server 120 between the client device 110 and various other client devices 160. The client device 110, using the IM client 103, may send and receive various attachments 112 as, or along with text instant messages 111. In accordance with the embodiments, the client device 110 may also lock or unlock various messages and/or attachments by sending a lock or unlock indication 113 to the server 120. The IM client 103 interacts with the operating system 104 using various application programming interfaces (APIs) which interact with a system kernel. The operating system 104 may be, for example, but not limited to, Android™ Ubuntu™, or other Linux™ based operating systems.

The server 120 includes a processor 121 which is operatively coupled to non-volatile non-transitory memory 130. The processor 121 is operative to execute application code 131 from memory 130 and to implement IM server 123. The IM server 123 may include various modules including message recap module 125, message locking module 127, and message type engine 129. Each of these modules may be stored as application code 131 which may be executed by the processor 121 in order to implement the various modules. The memory 130 may also store message type settings 132 and message status information 133.

The server 120 is operatively coupled to, and operative to communicate with, an IM database 140 using a database interface 141. The database interface 141 may utilize any suitable database operation protocol such as, but not limited to SQL, or any other suitable protocol. The IM database 140 may store IM status and other information and may format the IM status information into an IM status table 1100 in some embodiments. The server 120 may also be operative to interact and communicate with administration system 150 which is operative to communicate with the server 120 over an administration protocol 151. The administration protocol 151 may be implemented over the Internet and may be an enhanced version of the communication that occurs between the client device 110 and the server 120. For example, the administration protocol 151 may provide a view to the IM status table 1100 and allow revisions to be made through a GUI of the administration system 150.

The IM client 103 may be implemented using JavaScript and/or JavaScript Object Notation (JSON) for data handling in some embodiments. The server side component, IM server 123 manages IM messaging between client devices as well as handling user data including stored messages and attachments. In some embodiments, communication between the IM client 103 and IM server 123 may be implemented using, but not limited to, HTTP or HTTPS. In accordance with the embodiments, the messaging system provides a “recap” capability which provides a special view that is displayed on the client device 110 display either upon demand or at a predetermined time, for example, near the end of the day. The recap view shows the user any threads having messages that require a reply, but for which the user has not yet responded to by either replying or scheduling a reply. “Scheduling a reply” is a feature that enables a user to draft a reply and then specify a time and date for when the reply should be sent. The recap view shows threads organized by each message sender with a list of all messages received from that sender. The term “thread” as used herein refers to a message “conversation” involving the exchange of messages between two or more IM client users or between one IM client user and a predefined group of IM client users. A single initial message that was not part of a previously existing thread begins a new thread. Therefore a thread may include only a single message between two users in some situations. An IM client user has control over terminating a thread and beginning a new thread. Replying to a message in an existing thread will maintain the thread. Composing a new message to a participant of an existing thread will add the new message to the existing thread. Sending or receiving a message from a participant not having an existing thread will begin a new thread with that participant.

In some embodiments, as messages are received at the server 120, a status indicator associated with the message is set to a default setting which indicates that the message should be added to a “recap” folder and this information is maintained at the server 120. In other words, any incoming message is presumed to require a reply. When the message thread appears in the recap view, the user may reply to the message, schedule a reply to be sent at a later date and time, or delete the message. Any of these actions will remove the message thread from the recap view. The user may also manually remove the message thread from the recap view without replying or deleting the message, if the message does not require a reply.

In other embodiments, incoming messages are checked by the message type engine 129 to determine if the message requires a reply. If the message is of a type that does not require a reply, then the default indicator is automatically changed from the recap setting such that that particular message will not appear in the recap view. In embodiments having the message type engine 129, the determination of whether a given message requires a reply is made by the message type engine 129 by searching for “words of inquiry” and question mark punctuation within the message text. For example, the message type engine 129 will search for words including, but not limited to, “what,” “when,” “why,” “where,” “who,” “how,” “let me know,” “tell me,” or any other words or word combinations, etc. that indicate a possible inquiry for which a reply is warranted. The corresponding threads with any such identified messages will be added to the recap view.

In some embodiments, all incoming messages will be presumed to require a reply, however messages identified by the message type engine 129 will be highlighted, for example by changing the style or color of the message text, or by changing the style, shape or color of a message balloon that surrounds the message text. In other words, the user will visually be made aware of messages identified by the message type engine 129 as requiring a reply so that the user may address those messages first if desired. Once the user replies to a newly received message, or schedules a reply to be delivered later, the recap status indicator for the message is changed by the server 120 such that the particular message will not appear in the recap view on the client device 110.

Another feature of the messaging system 100 is a “lock” feature. The lock feature enables the user to “lock” a specific message to prevent inadvertent deletion of the message. The lock feature can also be used to keep messages in the recap view. The administration system 150 allows authorized system administrators to access the server 120 to lock certain messages and threads in certain situations.

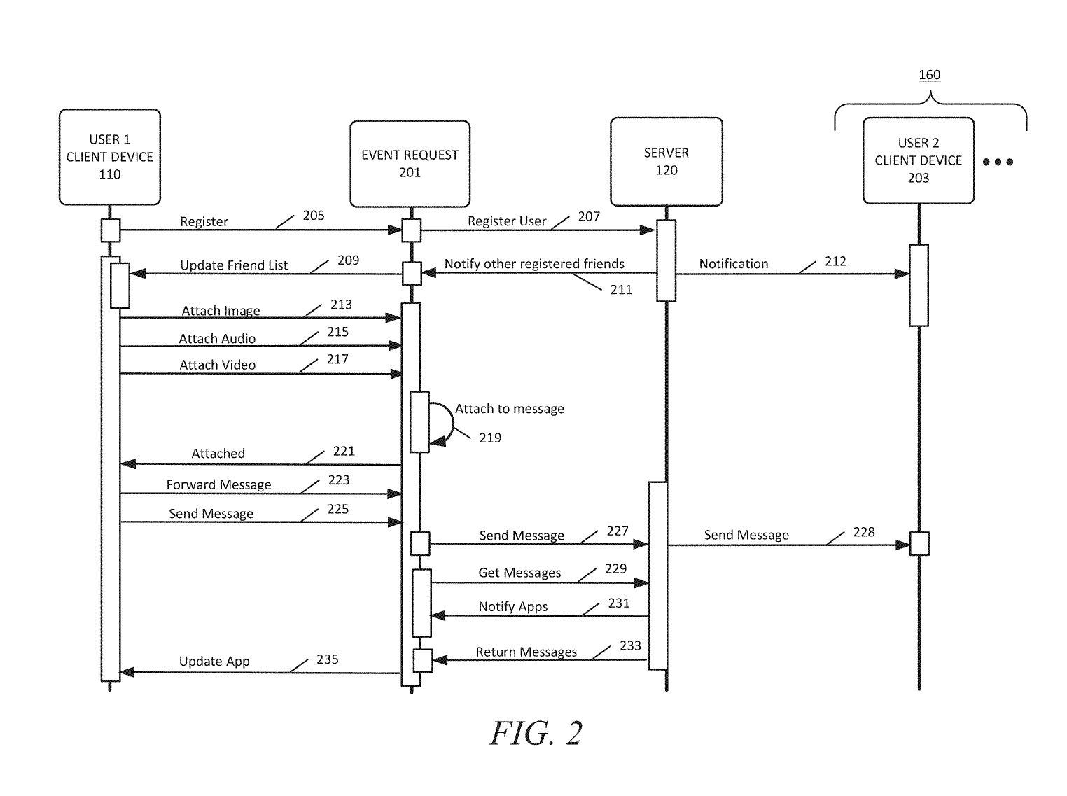

The messaging system 100 provides various other messaging capabilities such as illustrated in FIG. 2. FIG. 2 is a message flow diagram of various example operations of the messaging system 100 in accordance with an embodiment. The IM client 103 provides a user interface on the display 102, which the user of client device 110 may use to perform various operations illustrated in FIG. 2. The user 1 client device 110 includes the IM client 103 and operating system 104. The event request 201 block represents API calls for interactions between the IM client 103 and the IM server 123 resident on the server 120.

That is, the IM client 103 present on client device 110 generates event requests and interacts with the server 120 by the various messages and the operations shown in FIG. 2. Thus for example, the client device 110 user may register with the IM service which results in the IM client 103 sending register message 205 to the server 120 which in turn performs the register user operation 207. The server 120 will, in response, notify other registered friends by message 211 and the IM client will perform a corresponding “update friends list” operation 209. The server 120 will also send the notification message 212 to the other client devices 160, such as for example client device 203 (i.e. user 2's client device).

The user of client device 110 may also perform an attach image operation 213, an attach audio operation 215, or an attach video operation 217. The client device 110 will accordingly perform an “attach to message” operation 219 and indicate the image, audio or video as being “attached” 221 to the message. The user may perform a “forward message” operation 223 or a “send message” operation 225. Accordingly, the IM client 103 will generate the “send message” event 227 and the server 120 will accordingly perform the “send message” operation 228 and send the message to the recipient which in this example is client device 203 belonging to “user 2.”

Other operations between the IM client 103 and server 120 include the “get messages” operation 229, the “notify apps” operation 231 and the “return messages” operation 233 which the server 120 implements in response to the “get messages” operation 229. Accordingly, the IM client 103 performs an “update app” operation 235 in response to the “notify apps” operation 231 from the server 120.

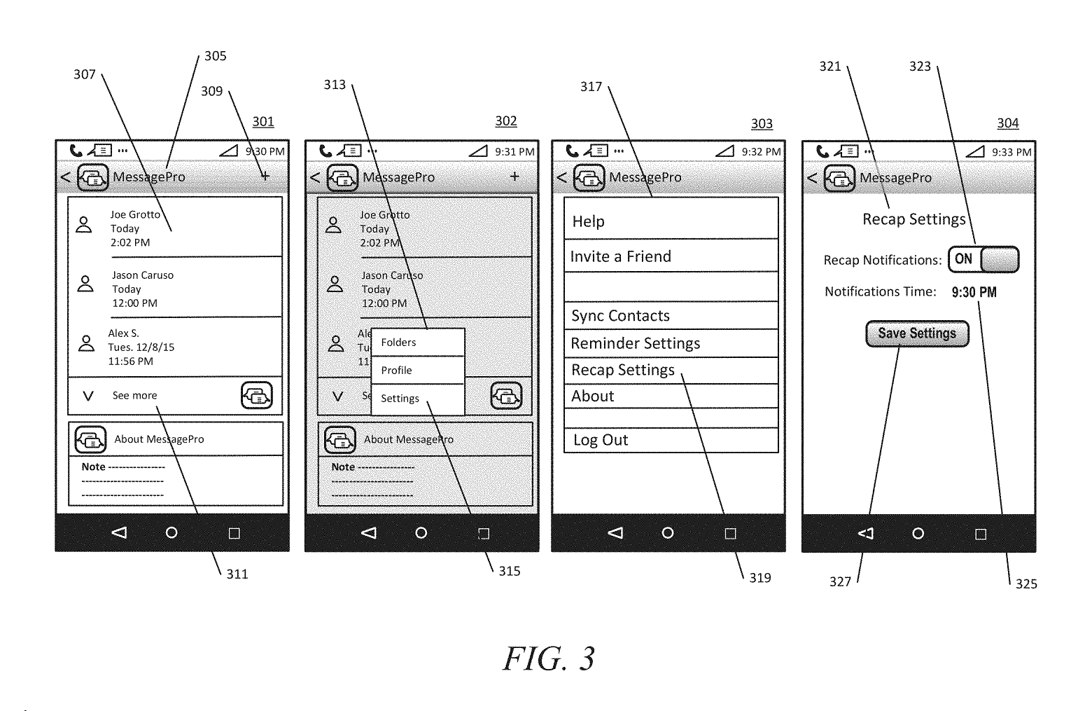

Turning to FIG. 3, a set of example client device display screenshots are provided that show application of recap settings in accordance with an embodiment. In screenshot 301 the IM client 103 displays a thread view 305 where each user who sent messages to the recipient, i.e. to the client device 110, shows up as a thread, such a s thread 307, in the thread view 305. Additional threads may be shown by selecting the “see more” option 311 which will scroll down to further threads if any exist. A particular thread, such as thread 307, may be selected from the thread view 305 in order to view messages associated with that thread.

From the thread view 305, the user may select a menu option 309 which will display the menu 313 shown in screenshot 302. The user may then select the settings options 315 which will display the settings menu 317 shown in screenshot 303. The user may select the “recap settings” 319 which will display the recap settings view 321 as shown in screenshot 304. The user may then turn the recap notifications on or off using the “recap notifications on/off” setting 323, and may set the notification time using “notifications time” setting 325. The user may then save settings by selecting the “save settings” button 327. The settings will be stored in memory 105 as settings 109 which are accessible by the IM client 103.

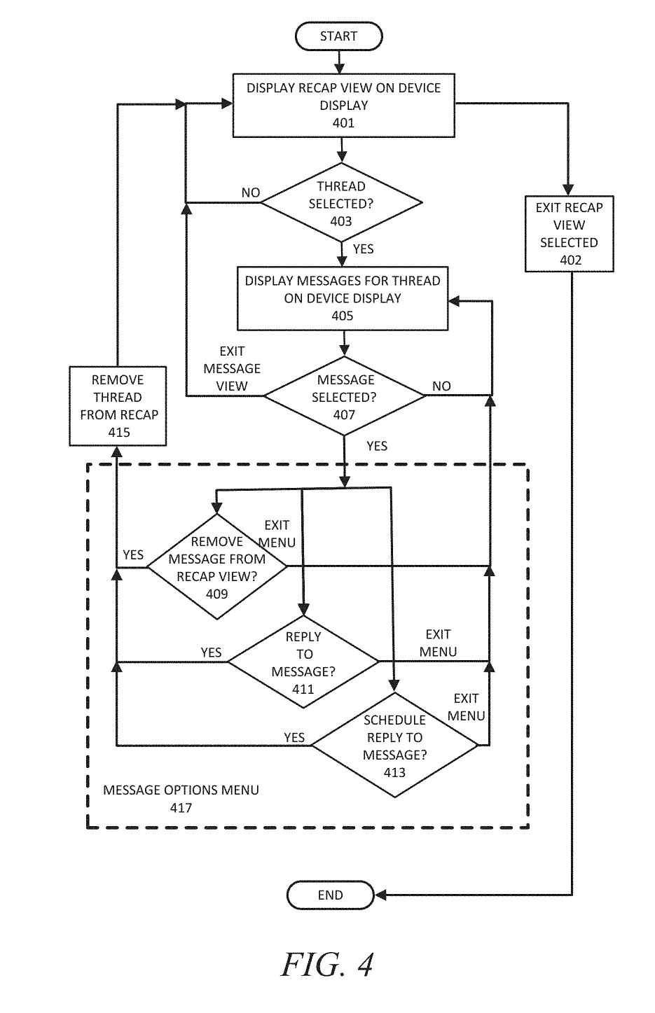

FIG. 4 is a flowchart illustrating an example recap operation on a client device in accordance with an embodiment. The method of operation begins and in operation block 401 the IM client 103 displays the recap view on the client device 110 display 102. The recap view appears as a thread view similar to the thread view 305. However, in the recap view, only threads that have messages requiring a reply will be included in the view. The recap view will be displayed until the user exits the recap view in operation block 402, or selects a thread for display in decision block 403. If the user exits the recap view in operation block 402, the recap operation terminates and the IM client 103 returns to the main thread view 305.

If the user has turned on recap notifications and set a time as described with respect to the screenshots of FIG. 3, then the IM client 103 will display the recap view on the device display 102 at the time selected by the user in accordance with the notification time setting 325. If user selects a thread in decision block 403, then in operation block 405 the IM client 103 will display the messages for that thread on the device display 102. In decision block 407, the user may then select a specific message by, for example, using the cursor or tapping the message on a touchscreen display to select the message. If the user exits message view in decision block 407, the IM client 103 will again display the recap view in operation block 401.

If a message is selected in decision block 407, then the IM client 103 will wait for input to a message options menu 417. For example, the user may remove the message from the recap view in decision block 409, may reply to the message in decision block 411, or may schedule a reply to the message in decision block 413, if the user selects one of the available corresponding message options menu 417 options. If the user performs one of these actions, then in operation block 415 the IM client 103 will remove the corresponding thread from the recap view and will return to operation block 401 and display the recap view on the device display 102. The user may exit the message options menu 417 at any time and return to the message view in operation block 405. Removing a message from the recap view in decision block 409 does not delete the message or the corresponding thread.

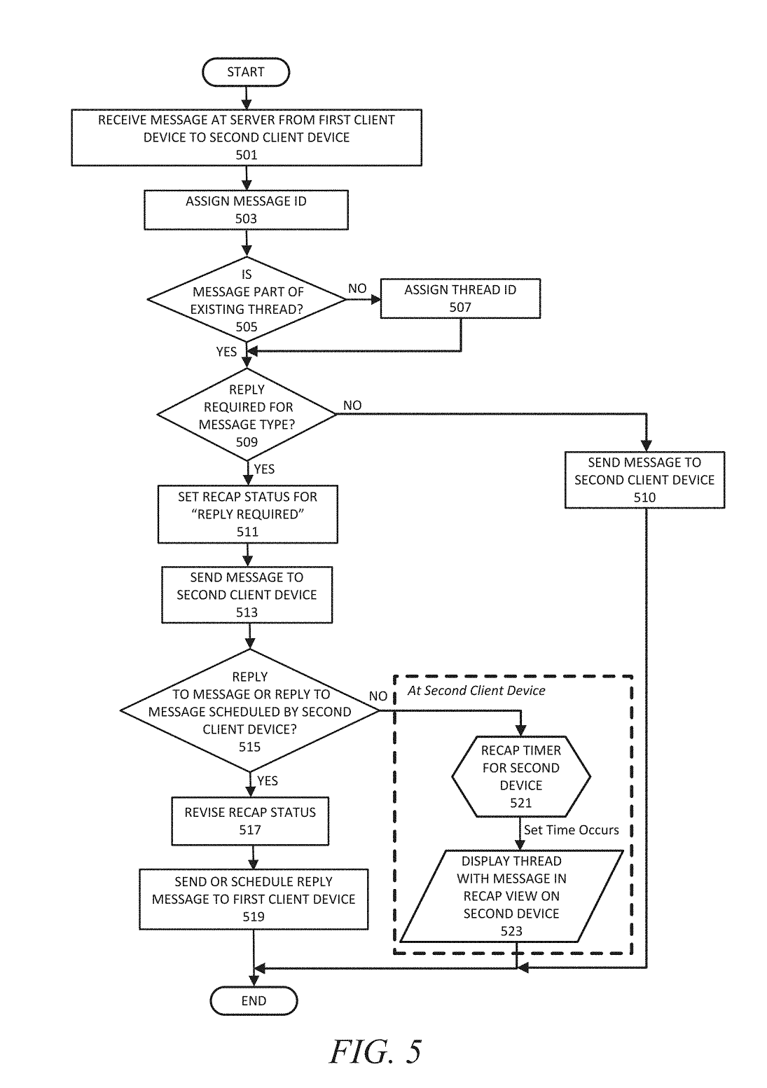

FIG. 5 is a flowchart illustrating an example recap operation on a server in accordance with an embodiment. In operation block 501, the server 120 will receive a message from a first client device to second client device, and in operation block 503 will assign a message ID. In decision block 505, if the message is part of an existing thread then, in decision block 509, the server 120 may determine whether a reply is required for the message type. In some embodiments, this operation will be performed by the message type engine 129. If the message is not part of an existing thread in decision block 505, then in operation block 507 the server 120 assigns a thread ID to the message to begin a new thread. In either case the method of operation proceeds to decision block 509. In decision block 509, if a reply is not required for the message type then, in operation block 510, the server 120 will send the message to the second client device and the method of operation terminates as shown.

However if a reply is required for the message type in decision block 509 then, in operation block 511, the server 120 sets the recap status for the message to indicate that a reply is required. In operation block 513, the server 120 sends the message to the second client device. In decision block 515, the server 120 waits for the second client device to provide a reply, reply schedule, or delete indication which may occur relatively soon or may recur at after some period of time. If the second client device replies to the message or schedules a reply then, in operation block 517, the server 120 revises the recap status for the particular message. In operation block 519, the server 120 sends the message to the first client device, or schedules the reply and sends the message to the first client device at the scheduled time and date. The method of operation then terminates as shown.

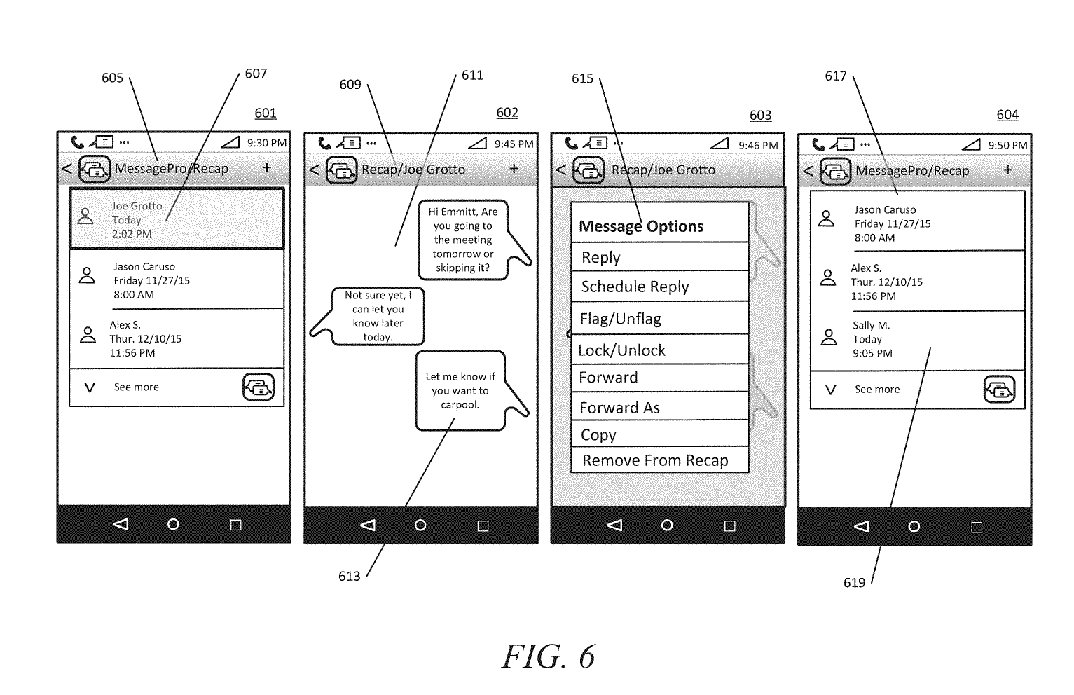

If a reply or a scheduled reply is not indicated from the second client device in decision block 515 then, at the second client device, the recap timer runs as shown in timer operation 521. After the recap notification time set by the user is reached in time operation 521 then, in operation block 523, the IM client 103 on the second client device will display the recap view with the thread containing the message. Accordingly, the thread will be shown in a recap thread view, an example of which is provided in FIG. 6.

Screenshot 601 illustrates an example recap thread view 605 which will include any threads that have a message which was not yet replied to, or which did not have a reply scheduled (unless the message was deleted by the user). In the example screenshot 601 the user receives the recap thread view 605 at 9:30 PM which was the time the user set in the example screenshot 304 using the notifications time setting 325. The user may select one of the threads, such as thread 607 (shown selected), which will then transition the GUI to recap message view 609 shown in screenshot 602. The recap message view 609 is associated with a particular sender associated with the thread 607. The sender's name may appear at the top of the recap message view 609 as shown in screenshot 602 and screenshot 603. Thus the various messages 611 are displayed and the user may select a message requiring a reply. Example message 613, which is the last message of the thread, is the message that requires a reply. In the recap message view 609, the last message of the thread will always be shown upon display of the recap message view 609 so that the user can take an action associated with that message. If the user selects the message 613, then the GUI will display the message options menu 615 as shown in screenshot 603. The message options menu 615 enables the user to reply, schedule a reply, flag or un-flag the message, lock or unlock the message, forward the message, forward the message as some other format such as e-mail, copy the message or delete the message. In some embodiments, the message options menu 615 will also provide a “remove from recap” option (not shown).

If the user selects “reply”, types (or dictates) a reply and sends it, schedules a reply, or deletes the message using the message options menu 615, then the IM client 103 will transition the GUI to screenshot 604 and display a revised recap thread view 617. The revised recap thread view 617 will no longer show thread 607 since the user has replied to the outstanding message which accordingly changes the recap status for the message and corresponding thread. Any other threads having messages requiring a reply will roll up into the revised recap thread view 617, such as thread 619 which was either previously hidden in in recap thread view 605 below the third thread, or was newly received. The user may then proceed to scroll to additional threads. In some embodiments, the user may select the “see more” option to scroll to additional threads according to the example shown in screenshot 601 and screenshot 604. In such embodiments, the “see more” option may only be present on the GUI when additional threads exist that would not fit on the display 102 concurrently. However in other embodiments, there is no “see more” option shown, but the user can scroll the threads to bring other threads into view on the display until the last thread in the view is reached.

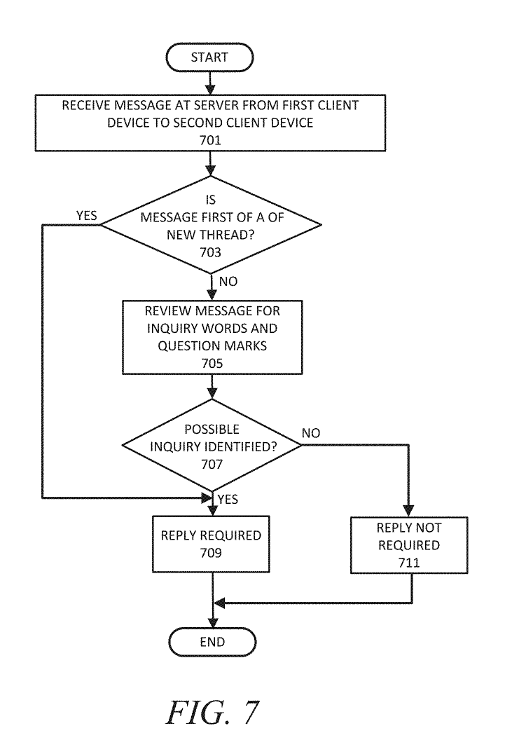

FIG. 7 is a flowchart illustrating an example message type determination operation on a server in accordance with an embodiment. The flowchart of FIG. 7 illustrates example operation of the message type engine 129. In operation block 701, the server 120 receives a message from a first client device to a second device. In decision block 703, the message type engine 129 will check whether the message is the first of the new thread or whether the message is associated with an existing thread. In some embodiments, if the message is the first message of a new thread then, in operation block 709, the message type engine 129 will presume that a reply is required. In other embodiments, this presumption will not be made, and all messages will be reviewed in operation block 705. In embodiments in which this presumption is made for new message threads, the server 120 message recap module 125 will set the recap status to “reply required” and will accordingly update the message status table 1100 in the IM database 140. The method of operation will then terminate as shown, and no further action will be taken until the recipient of the message replies, schedules a reply or deletes the message.

If in decision block 703 the message type engine 129 determines that the message is not the first of a new thread then, in operation block 705, the message type engine 129 will review the message for inquiry words and question marks. As described above, in some embodiments, all messages may proceed directly to review in operation block 705.

In operation block 705, the message type engine 129, searches for “words of inquiry” and question mark punctuation within the message text. In one example embodiment, the message type engine 129 will search for words including, but not limited to, “what,” “when,” “why,” “where,” “who,” “how,” “let me know,” “tell me,” or any other words or word combinations etc. that indicate a possible inquiry for which a reply is warranted. The corresponding threads with any such identified messages will be added to the recap view. Therefore, in decision block 707, if a possible inquiry is identified then, in operation block 709, the message type engine 129 will communicate with the message recap module 125 and the message status will be designated “reply required” and the method of operation terminates as shown. If a possible inquiry is not identified in decision block 707 then, in operation block 711, the message recap module 125 will designate the messages “reply not required” and the method of operation will terminate as shown.

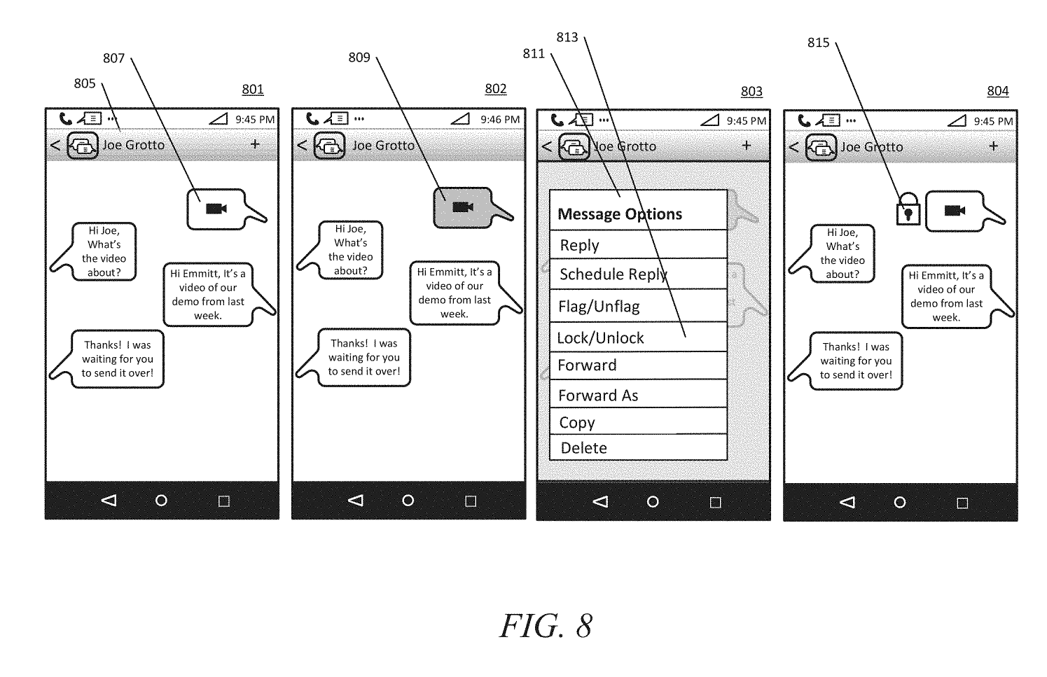

FIG. 8 is a set of example client device display screenshots showing an example lock operation in accordance with an embodiment. In example screenshot 801, a message view 805 for particular sender is displayed. The user may select any one of the messages in the message view 805. As an example, if the user selects message 807 then the GUI will show message 807 as a selected message 809 in screenshot 802. The selected message 809 is a video attachment in this example. In screenshot 803, selection input for selected message 809 transitions the GUI to display the message options menu 811 which includes options; “reply,” “schedule reply,” “flag/unflag,” “lock/unlock,” “forward,” “forward as,” “copy,” and “delete.” If the user selects the lock/unlock option 813, then the IM client 103 GUI will display a lock icon 815 next to the message as shown in screenshot 804. Accordingly, the message will not be allowed to be deleted and any subsequent attempts to delete the message (at either the client device or server) will be prevented and the message will be preserved. The lock settings will be stored in memory 105 in settings 109 which are accessible by the IM client 103.

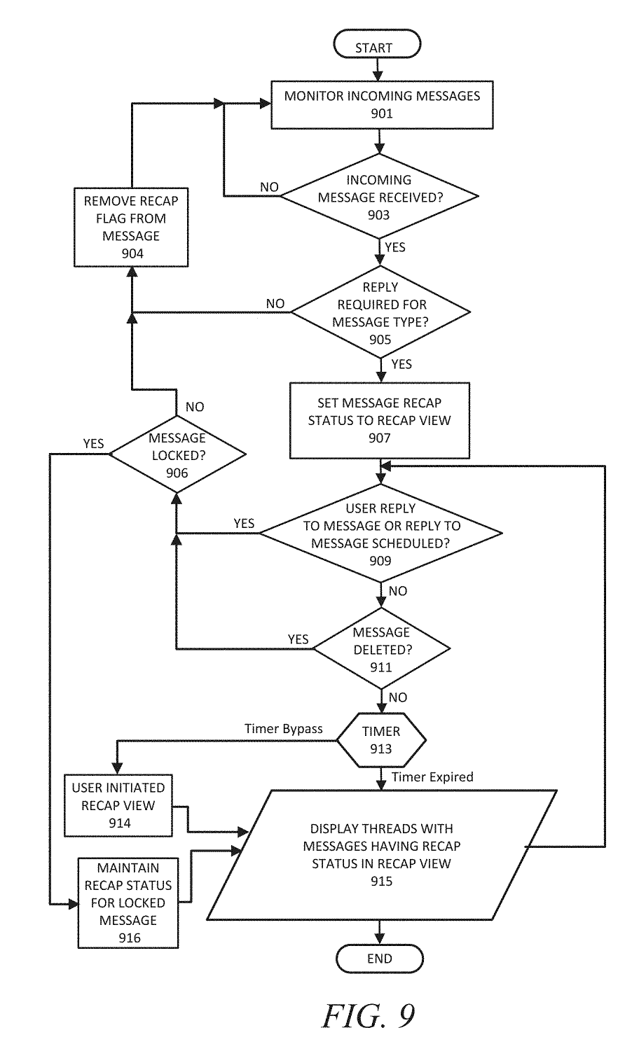

FIG. 9 is a flowchart illustrating example messaging system 100 operations including recap operations and lock operations in accordance with an embodiment. In operation block 901, the server 120 monitors incoming messages. If an incoming message is received in decision block 903 then, in decision block 905, the message type engine 129 may check if a reply is required for the message. The IM server 123 continues to monitor for incoming messages in operation block 901 in a continuous manner as long as the server 120 is online.

If in decision block 905, the message type engine 129 determines that a reply is not required for the message then, in operation block 904, the message recap module 125 will remove the recap flag from message and the IM server 123 will continue to monitor incoming messages in operation block 901. If a reply is required for the message in decision block 905 then, in operation block 907, the message recap module 125 will set the recap status setting for the message such that the corresponding thread will be displayed in the recap view on the corresponding client device. In decision block 909, the IM server 123 will monitor for a reply or scheduled reply, and in decision block 911 will monitor for a delete operation.

If a reply is sent or scheduled in decision block 909, or if the message is deleted in decision block 911, then in decision block 906 the message locking module 127 checks whether the message has been locked. If the message has not been locked then, in operation block 904, the message recap module 125 will remove the recap flag from the message and the IM server 123 will continue to monitor incoming messages in operation block 901.

If a reply is not sent or scheduled in decision block 909, and the message is not deleted in decision block 911, then the recap timer 913 will run until either the user performs a manual timer bypass or the timer expires at the notifications time setting 325. If the user bypasses the recap timer 913 in operation block 914, by initiating a recap view directly with the IM client 103, then in operation block 915 the IM client 103 will display the messages having a recap flag in the recap thread view along with any other thread having a message requiring a reply. This will also occur if the recap timer 913 expires. The recap timer 913 automatically resets and will cause the recap view to be displayed again each day at the set time. As described above, the user may also access the recap view at any time by bypassing the recap timer 913 in operation block 914 (i.e. “user initiated recap view”).

Returning to decision block 906, if the message is locked then, in operation block 916 the message recap module 125 maintains the recap status for the locked message and the message is also prevented from being deleted. The message will continue to appear in the recap thread view in operation block 915. The method of operation then ends as shown.

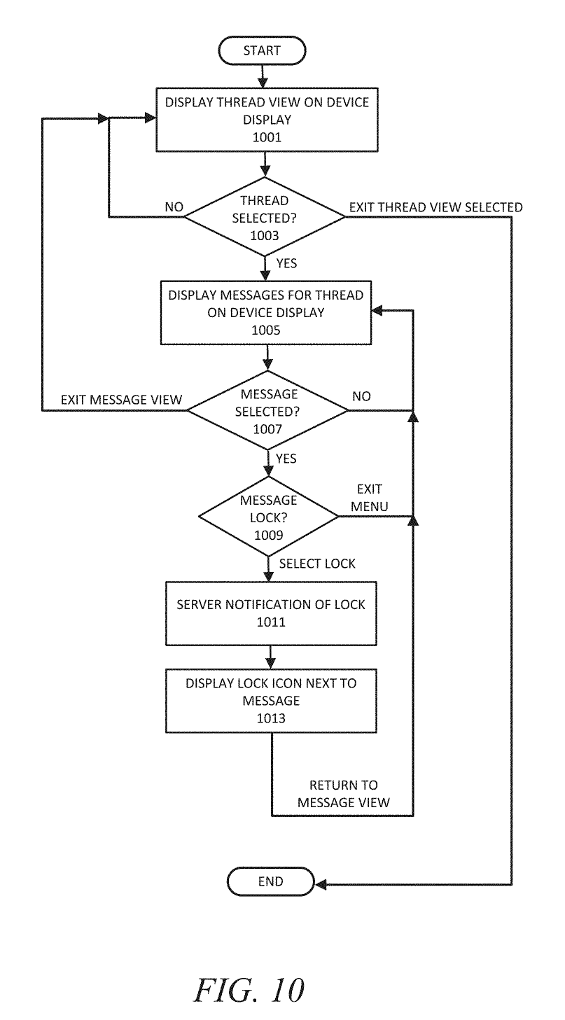

FIG. 10 is a flowchart illustrating an example lock operation in accordance with an embodiment. In operation block 1001, the IM client 103 displays the thread view on the client device display. In decision block 1003, the user may select a thread in order to display the corresponding message view, or may exit the thread view which will end the operation and exit the IM client 103. The IM client 103 will continue to display the thread view on the display in operation block 1001 until a thread is selected in decision block 1003. If a thread is selected in decision block 1003 then, in operation block 1005, the IM client 103 will display messages for the thread on the device display 102. The IM client 103 will then wait for a message to be selected in decision block 1007.

If the user exits the message view in decision block 1007 then the IM client 103 returns to operation block 1001 and displays the thread view. If no message is selected in decision block 1007, then the IM client continues to display the messages for the thread in operation block 1005. If a message is selected in decision block 1007 then, in decision block 1009, the user may select to lock the message. If the user exits the menu then the IM client 103 will return to operation block 1005 and display the message view for the thread. If the user selects to lock the message in decision block 1009 then, in operation block 1011, the IM client 103 will send notification of the message lock to the server 120, and the server 120 will update the IM message status table 100 in the IM database 140 accordingly. In operation block 1013, the IM client 103 will display a lock icon next to the message on the client device display 102. The IM client 103 will then return to the message view in operation block 1005. The IM client 103 will remain in the message view until the user exits the message view and returns to the thread view. The user may exit the thread view which exits the IM client 103.

In some embodiments, the administration system 150 may communicate with the message locking module 127, and place locks on various types of messages and/or threads. For example the administration system 150 may interact with message status table 1100 in the IM database 140 and change lock status for certain threads and/or certain users. In one example application, the administration system 150 may be used in a situation where a litigation hold is required. In that case, certain users communicating with a given device such as client device 110 may be monitored by the IM server 123 through message type settings 132 set by the administration function 150. That is, the IM server 123 may monitor incoming messages in conjunction with message type settings 132 to see if any specified users and/or specified threads are subject to a lock. If locks are indicated in message type settings 132, then the IM server 123 may communicate with message locking module 127 to lock any of the threads or messages accordingly.

The administration function 150 may be operated by a business that provides the IM client 103 to the client device 110 and to the other client device 160. In other words, the administration function 150 may be limited to operations locking messages or may be limited to locking messages only for client devices within its organization. However it is to be understood that messages arriving from external sources, external to the business, may be locked. In other instances, the administration function 150 may be provided as a service to businesses requiring retrieval of IM messages for various purposes such as, but not limited to, litigation holds or to meet other compliance requirements in which such ESI must be recorded and accounted for.

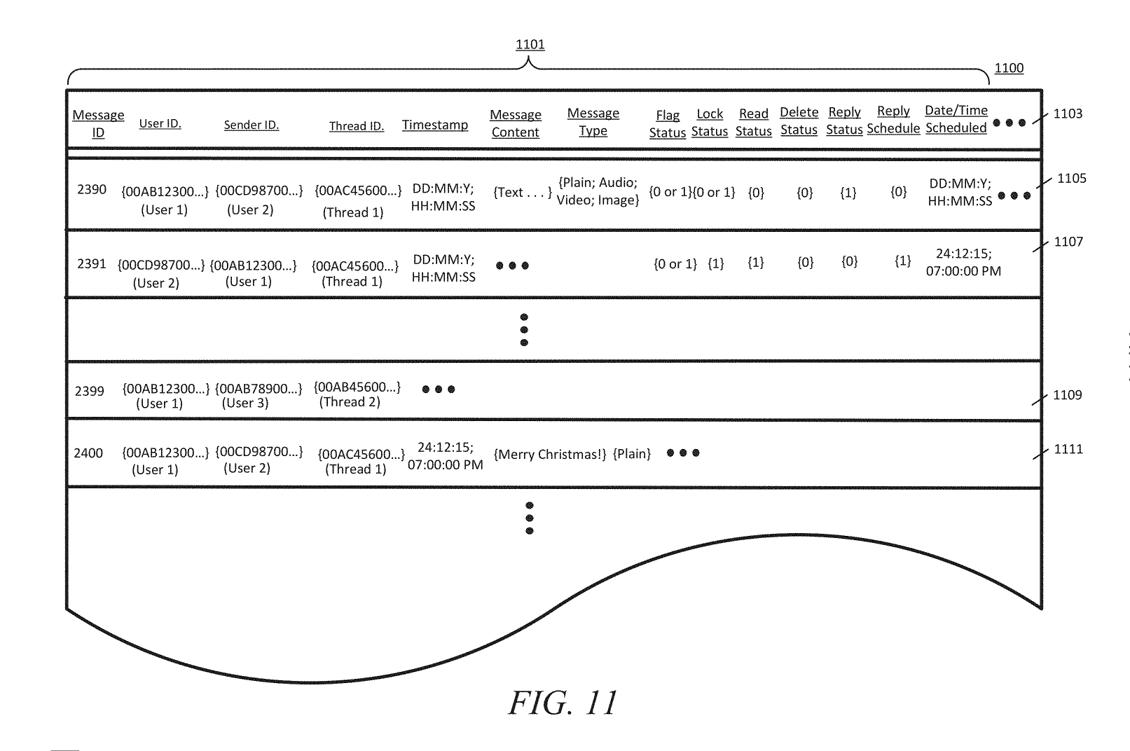

FIG. 11 is a diagram of an example message status table 1100 stored in an IM database 140, in accordance with an embodiment. Some of the information contained in the message status table 110 may be included with messages sent to and from client devices as metadata included as part of the message header or embedded within the message body. The metadata may also be encrypted in some embodiments such that it is not readable by the client device and is not accessible to the user. The example message status table 1100 includes various columns 1101 including, but not limited to; “message ID,” “user ID,” “sender ID,” “thread ID,” “timestamp,” “message content,” “message type,” “flag status,” “lock status,” “read status,” “delete status,” “reply status,” “reply schedule,” and “date/time scheduled” for a scheduled reply. These example columns are identified by header row 1103 in the example message status table 1100.

As described above, when a new message arrives at server 120, the IM server 123 will assign a message ID and will capture the user ID of the recipient and the sender ID. If the thread is a new thread, then a new thread ID will be assigned, or if the message is part of an existing thread that thread will be indicated in thread ID column. The timestamp consists of the day and time that the message was received by the server 120 and this timestamp may also be indicated to the receiving client device. The message content will include either the text of the message or may include attachments that were included such as a video file, audio file or image file. The “message type” column indicates what type of message content is included in the message. The flag status is an option settable by the user such that the user may set a personal reminder for the message. The flag status may appear as an indicator next to the message on the client device display. The IM server 123 changes the flag status to “0” or “1” in the message status table 1100 depending on the user setting.

A lock status entry of “0” or “1” will indicate whether users have locked or unlocked the message were “1” may indicate that the message is locked and “0” may indicate that the message is unlocked. A message lock will prevent the message from being deleted; therefore the delete status will remain “0” for any message having a lock status of “1.” The “read status” column indicates whether the message was read by the user where “0” may indicate the message has been unread and “1” may indicate that the message is read. “Delete status” will remain “0” as long as the user has not deleted the message at the client device. The delete status will be changed to “1” if the message has been deleted by the user.

In example table row entry 1105, the “reply status of “1” indicates that the user has replied to the message corresponding to message ID 2390. The reply status will also be updated to “1” for a scheduled reply. In example table row entry 1105, a reply was not scheduled therefore the reply schedule column is “0.” Message ID 2391 shown in example table row entry 1107 represents the reply from user 1 to user 2. Therefore as can be seen, the thread ID is the same for message ID 2390 in table row entry 1105 and for message ID 2391 in table row entry 1107. Example table row entry 1109 is related to message ID 2399 and is a message sent from user 3 to user 1 and which as can be seen to have a different thread ID than message ID 2390 and message ID 2391. Example table row entry 1111 is related to message ID 2400 and is a reply from user 2 to user 1 that was scheduled for message ID 2391. In example row entry 1107 user 2 scheduled a reply for message ID 2391 to be sent at 7:00 PM on Dec. 24, 2015. The reply schedule column entry is therefore “1” and indicates that the user scheduled the reply. In example row entry 1111, the message ID 2400 has a timestamp of 7:00 PM on Dec. 24, 2015, and is related to thread 1, the same thread as message ID 2391. The message “Merry Christmas!” is a plain text message that has been sent by user 2 to user 1 as message ID 2400. After sending the message, the server 120 may update the reply status column to “1” for message ID 2391 in some embodiments.

The various embodiments also include non-volatile, non-transitory computer readable memory that contains executable instructions, for execution by at least one processor, that when executed, cause the at least one processor to operate in accordance with the IM client 103 functionality herein described for a client device. The various embodiments also include non-volatile, non-transitory computer readable memory that contains executable instructions, for execution by at least one processor, that when executed, cause the at least one processor to operate in accordance with the IM server 123, message recap module 125, message locking 127 module and/or message type engine 129 functionality herein described for a server. The non-volatile, non-transitory computer readable memory may be any suitable non-volatile, non-transitory, memory such as, but not limited to, programmable chips such as EEPROMS, flash ROM (thumb drives), compact discs (CDs) digital video disks (DVDs), etc., that may be used to load executable instructions or program code to other processing devices or electronic devices such as those client devices and/or servers or other like devices that may benefit from the features of the herein described embodiments.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A method comprising:
maintaining, by a server, message status information for a plurality of messages, the status information comprising an indicator for each message that indicates if a reply is required; and
providing a view to a first client device, of only messages for which a reply is required by the first client device according to the message status information, the view displayable on a display of the first client device.

2. The method of claim 1, further comprising:
providing the view to the first client device as a thread where the thread corresponds to a second client device in communication with the first client device.

3. The method of claim 2, further comprising:
providing the view as a plurality of threads where each thread corresponds to communication with a different client device corresponding to a different user, in communication with the first client device, where each thread comprises a message requiring a reply by the first client device.

4. The method of claim 1, further comprising:
determining, by the server, that a message sent to the first client device requires a reply by the first client device; and
updating the message status information to indicate that the message requires areply.

5. The method of claim 4, wherein determining, by the server, that a message sent to the first client device requires a reply by the first client device, comprises:
reviewing the message for inquiry words.

6. The method of claim 1, further comprising:
determining, by the server, that a message in the view has been replied to by the first client device; and
updating the message status information by the server such that the message will be removed from the view.

7. The method of claim 1, further comprising:
determining, by the server, that a message in the view has been replied to by the first client device; and
removing the replied to message from the view.

8. A messaging system comprising:
a database operative to store message status information for a plurality of messages for a plurality of client devices;
a server, operatively coupled to the database, the server operative to:
maintain the message status information for a plurality of messages, the status information comprising an indicator for each message that indicates if a reply is required; and
provide a view to a first client device, of only messages for which a reply is required by the first client device according to the message status information, the view displayable on a display of the first client device.

9. The messaging system of claim 8, wherein the server is further operative to:
provide the view to the first client device as a thread where the thread corresponds to a second client device in communication with the first client device.

10. The messaging system of claim 9, wherein the server is further operative to:
provide the view as a plurality of threads where each thread corresponds to communication with a different client device corresponding to a different user, in communication with the first client device, where each thread comprises a message requiring a reply by the first client device.

11. The messaging system of claim 8, wherein the server is further operative to:
determine that a message sent to the first client device requires a reply by the first client device; and
update the message status information in the database to indicate that the message requires a reply.

12. The messaging system of claim 11, wherein the server is further operative to determine that a message sent to the first client device requires a reply by the first client device, by reviewing the message for inquiry words.

13. The messaging system of claim 8, wherein the server is further operative to:
determine that a message in the view has been replied to by the first client device; and
update the message status information such that the message will be removed from the view.

14. The messaging system of claim 8, wherein the server is further operative to:
determine that a message in the view has been replied to by the first client device; and
remove the replied to message from the view.

15. A method comprising:
establishing, by a first client device, an Internet Protocol (IP) connection with a server;
receiving, by the first client device, a plurality of messages with each message including a status indicator from the server that indicates whether a reply is required; and
displaying on a display of a first client device, a view showing messages that require a reply based on the messages' corresponding status indicators.

16. The method of claim 15, further comprising:
displaying the view at a predetermined time.

17. The method of claim 15, further comprising:
displaying the view as a plurality of threads where each thread corresponds to communication with a different client device corresponding to a different user, in communication with the first client device, where each thread comprises a message requiring a reply by the first client device.

18. The method of claim 15, further comprising:
determining that the first client device has replied to the first message; and
removing the first message from the view.

19. The method of claim 16, further comprising:
detecting expiration of a timer setting, the timer setting indicating the predetermined time; and
displaying the view at the time of expiration of the timer setting.

20. The method of claim 15, further comprising:
detecting user input to select a first message shown in the view;
determining that the user has scheduled a reply to the first message; and
removing the first message from the view.

21. The method of claim 20, further comprising:
sending an indicator to the server to notify the server of the schedule reply to the first message.

22. A client device comprising:
a transceiver, operative to establish a wireless Internet Protocol (IP) connection with a server;
a display; and
at least one processor, operatively coupled to the transceiver and to the display, the processor operative to:
receive a plurality of messages with each message including a status indicator from the server that indicates whether a reply is required; and
display on the display, a view showing messages that require a reply based on the messages' corresponding status indicators.

23. The client device of claim 22, wherein the at least one processor is further operative to:
display the view on the display at a predetermined time.

24. The client device of claim 22, wherein the at least one processor is further operative to:
display the view as a plurality of threads where each thread corresponds to communication with a different client device corresponding to a different user, where each thread comprises a message requiring a reply by the client device.

25. The client device of claim 22, wherein the at least one processor is further operative to:
determine that the client device has sent a reply to the first message; and
remove the first message from the view.

26. The client device of claim 23, wherein the at least one processor is further operative to:
detect expiration of a timer setting, the timer setting indicating the predetermined time; and
display the view at the time of expiration of the timer setting.

27. The client device of claim 22, wherein the at least one processor is further operative to:
detect user input to select a first message shown in the view;
determine that the user has scheduled a reply to the first message; and
remove the first message from the view.

28. The client device of claim 27, wherein the at least one processor is further operative to:
send an indicator to the server to notify the server of the scheduled reply to the first message.
